(19) United States
(12) Patent Application Publication
(10) Pub. No.: US 2009/0051146 A1
(43) Pub. Date: Feb. 26, 2009

(54) Snap-in attachment of inflator for airbag

(75) Inventor: Jerome Bosch, Romeo, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/222,877

(22) Filed: Aug. 18, 2008

Related U.S. Application Data
(60) Provisional application No. 60/935,623, filed on Aug. 22, 2007.

(51) Int. Cl. B60R 21/217; B60R 21/205

(52) U.S. Cl. 280/728.2

(57) ABSTRACT

An airbag module for a vehicle comprises a housing for an airbag and an inflator configured to be mounted on the housing. The housing includes at least one integral locking component to lock the inflator into a mounted, in-use position on the housing. The component comprises an undercut section formed in a back surface of the housing and/or a bendable tab formed in a back surface of the housing. The inflator can be rotated from a first position to a second, mounted position. In the first position, the inflator is located against the back surface but can be freely removed from the housing. In the second position, the inflator flange is held in place in a direction perpendicular to the back surface of the housing by the at least one undercut section.

### CROSS-REFERENCE TO RELATED APPLICATION

This application claims priority to U.S. Provisional Application No. 60/935,623, filed Aug. 22, 2007, which is incorporated herein by reference in its entirety.

### BACKGROUND

The present invention relates generally to automotive airbags. More specifically, the invention relates generally to automotive airbags and a simplified attachment method of an airbag inflator to an airbag module housing.

Airbags are provided in vehicles for the protection of drivers and passengers in the event of a vehicle crash. It is desirable to maintain the integrity of the airbag construction and operation while reducing manufacturing and assembly costs when possible.

Current airbag designs generally use screws, studs, and/or nuts to attach the airbag inflator to the airbag module. Mechanical fasteners to affix the airbag inflator to the airbag module can be somewhat expensive to manufacture and assemble. Additional cost is added not only from the hardware, but also from the process equipment needed, e.g., driver and torque controllers. While this method offers satisfactory performance, reducing the manufacturing and assembly costs by simplifying the attachment process would be desirable.

### SUMMARY

According to one exemplary embodiment, an airbag module is provided. The airbag module comprises a housing for an airbag, and an inflator configured to be mounted on the housing. The housing comprises at least one undercut section with a slot into which an inflator flange can be slid to mount the inflator onto the housing.

According to another exemplary embodiment, an airbag module for a vehicle is provided. The airbag module comprises a housing for an airbag, and an inflator configured to be mounted on the housing. The housing includes at least one integral locking component to lock the inflator into a mounted, in-use position on the housing.

According to yet another exemplary embodiment, a method of attaching an inflator to an airbag module housing is provided. The method comprises placing the inflator in a first position against a back surface of the airbag module housing, and rotating the inflator to a second position such that an inflator flange slides into a slot created by an undercut section located on the back surface of the housing, thus causing the inflator to be held in a direction perpendicular to the back surface of the housing.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is perspective view of the interior of a vehicle illustrating the location of a driver side airbag and a passenger side airbag according to an exemplary embodiment.

FIG. 2 is a cross section of an airbag module along line A-A as shown in FIG. 3B, containing a disk style inflator according to an exemplary embodiment.

FIG. 3A is a front view of an airbag inflator positioned upon a back side of an airbag housing prior to attachment according to an exemplary embodiment.

FIG. 3B is a front view of an airbag inflator positioned upon the back side of an airbag housing subsequent to attachment according to an exemplary embodiment.

FIG. 4 is a perspective view of the back side of a passenger airbag housing according to an exemplary embodiment.

FIG. 5 is a detailed perspective view of undercut features and bendable tabs utilized for attachment of an airbag inflator to an airbag housing according to an exemplary embodiment.

FIG. 6 is a cross section of an airbag module along line B-B as shown in FIG. 3B, in which a bendable tab is shown abutting a flange of a disk style inflator.

FIGS. 7A-7D are partial cross sections of an airbag module along line C-C as shown in FIG. 3B, in which the airbag module is shown in various stages of serviceability.

FIG. 8 is a partial perspective view, sliced at a back surface of an airbag module, looking towards the top of undercut sections from the back surface.

FIGS. 9A and 9B are front detailed perspective views of two types of non-integral bendable tabs.

FIGS. 9C and 9D are rear detailed perspective views of the bendable tabs of FIGS. 9A and 9B, respectively.

FIGS. 10A and 10B are longitudinal cross sections of two types of non-integral bendable tabs.

### DETAILED DESCRIPTION

One embodiment relates to a method of attaching an airbag inflator to an airbag module housing. The method comprises moving flanges, located at the perimeter of the inflator, into undercut sections, or slots, positioned on the airbag module housing. The flanges are held in place in a vertical direction by the undercut sections. The housing can also include bendable tabs and/or interlock features to prevent the inflator flange from rotating out from under the undercut sections.

According to another embodiment, an airbag module comprises a housing for an airbag, and an inflator configured to be mounted on the housing. The housing includes at least one integral locking component to lock the inflator into a mounted, in-use position on the housing.

Referring generally to the FIGURES, an exemplary embodiment of a simplified method for attaching an airbag inflator to an airbag module housing is shown. This method allows for positive fastening without additional hardware such as screws, studs, and/or nuts. Additionally, the equipment necessary to accomplish the method can be simplified.

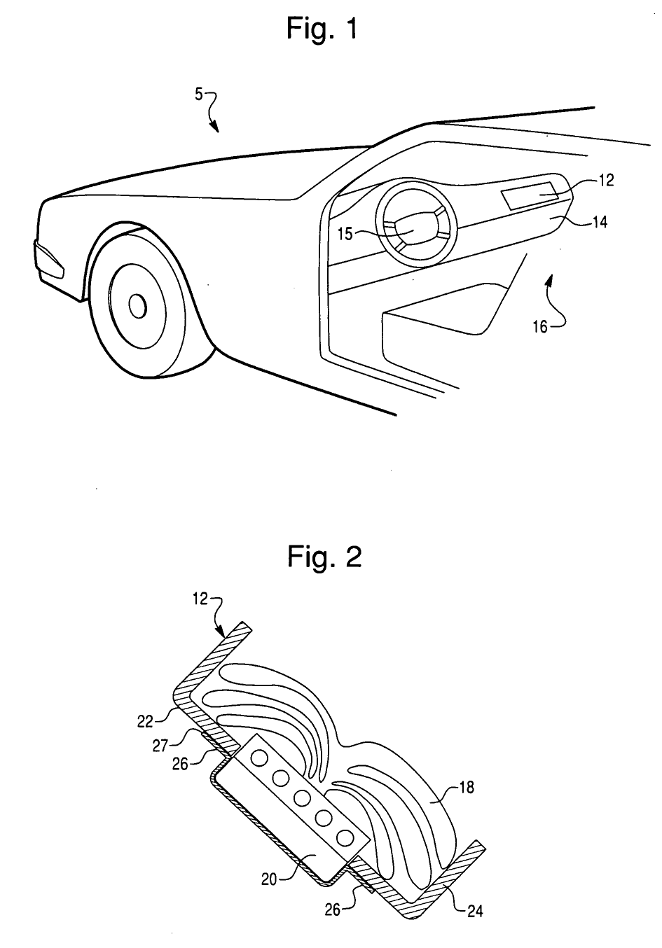

Referring to FIG. 1, a vehicle 5 is shown according to an exemplary embodiment. Vehicle 5 is shown with a passenger airbag 12 positioned on the dashboard 14 generally in front of a vehicle passenger. In the event of a vehicle crash, the passenger airbag 12 can be deployed into the vehicle compartment 16 to provide protection for the vehicle occupants. An airbag may also be positioned in a steering wheel 15 for protection of a vehicle driver. The airbag may also be positioned in any other suitable location in the vehicle.

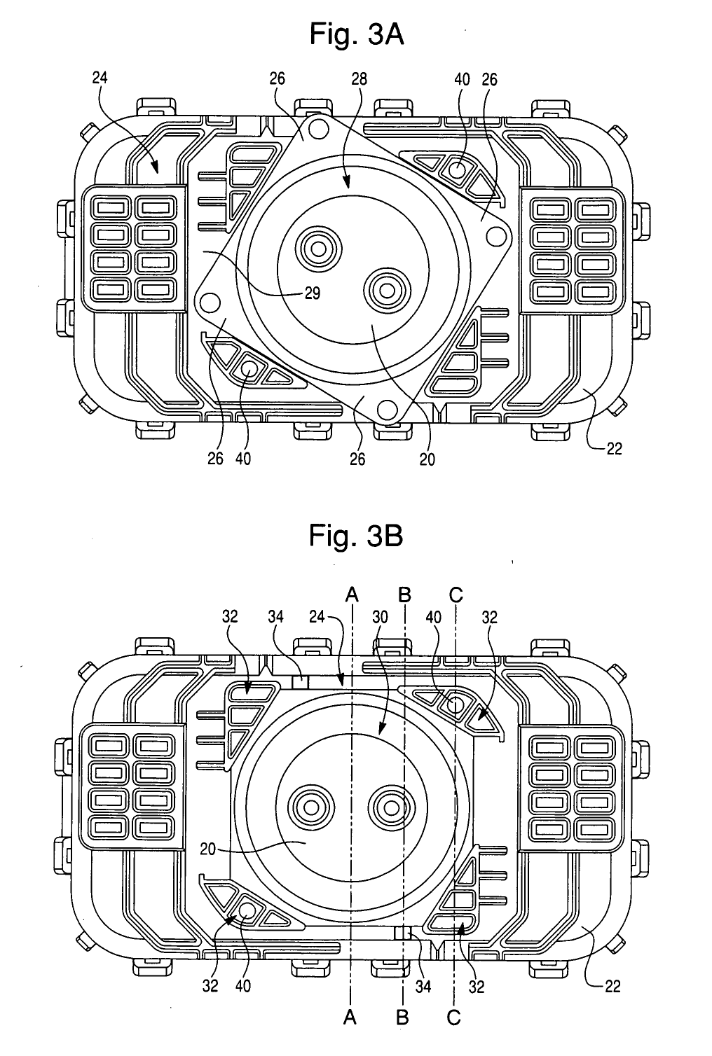

As illustrated in FIG. 2, passenger airbag 12 generally includes an airbag cushion 18 and a disk style inflator 20. The inflator 20 is attached to the back side 22 of an airbag module housing 24. The back side 22 of the airbag module housing 24 has a back surface 29 (FIG. 3A). The perimeter of inflator 20 includes a flange 26 that is generally square on four corners (shown in FIG. 3A). The flange 26 includes a side edge 27. It will be recognized that the inflator 20 may be any suitable type of inflator and that the inflator flange 26 may comprise any suitable shape or configuration.

A method of attaching an inflator 20 to an airbag module housing 24 is illustrated in FIGS. 3A and 3B, according to an exemplary embodiment. Before the inflator 20 is loaded, bendable tabs 34 located on the airbag module housing 24 are slightly raised from the back side 22 of the airbag module housing 24. The tabs 34 have inside edges 37. The inflator 20 is loaded from the back side 22 of the airbag module housing 24. In a first position 28, an initial position shown in FIG. 3A, the inflator 20 is approximately 30° from a second position 30, a final position shown in FIG. 3B. In this first position 28, the bendable tabs 34 located on the airbag module housing 24 are compressed so that they are coplanar with the back side 22 of the airbag module housing 24. Applying a 30° twist to the body of inflator 20 moves inflator 20 from first position 28 to second position 30. In the second position 30, flange 26 is held in place in a direction perpendicular to the back surface 29 by undercut sections 32. The bendable tabs 34 return to their original raised positions. In this second position 30, the inside edges 37 of the tabs 34 contact the side edge 27 of the flange 26. The tabs 34 prevent the inflator 20 from rotating out from under the undercut sections 32 and, thus, lock the inflator 20 in the second position 30, sometimes referred to as a mounted or in-use position. It is possible for the airbag module housing 24 to have only a single bendable tab 34, or any suitable number of tabs 34 and/or undercut sections 32. The bendable tab 34 can either be an integral part of the airbag module housing 24 or separate pieces that are fastened to the airbag module housing 24 as a secondary operation prior to positioning the inflator 20.

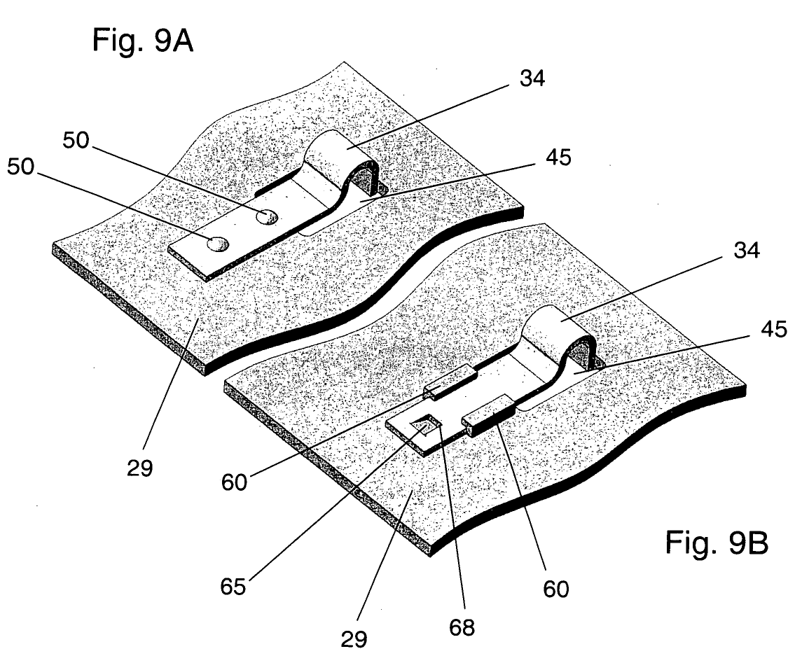

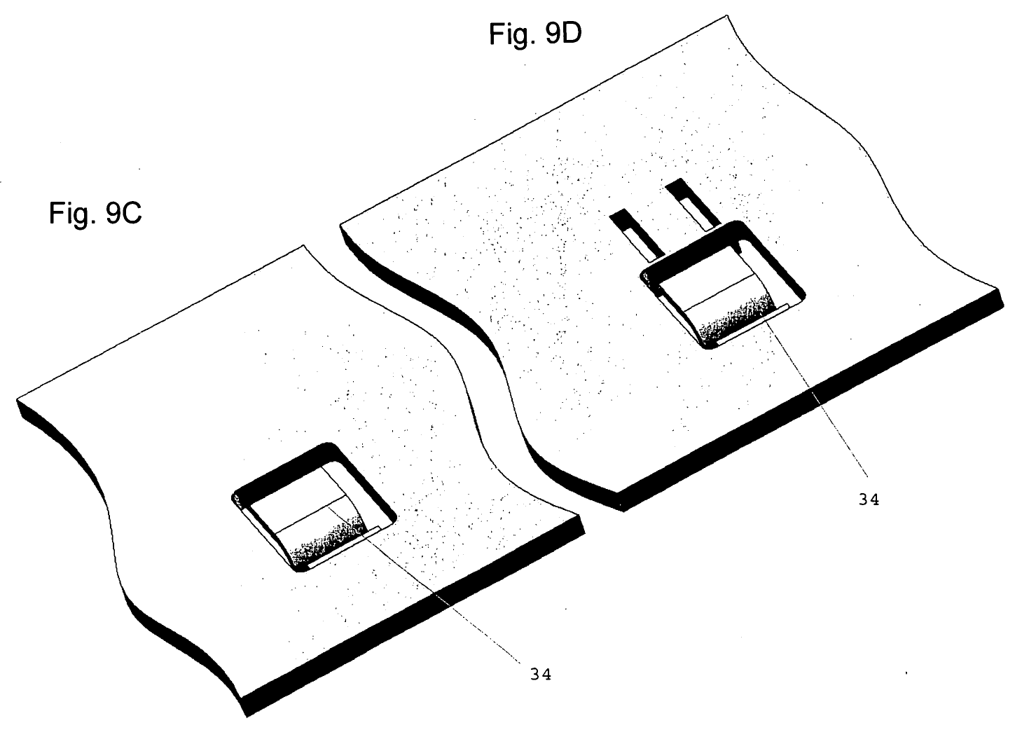

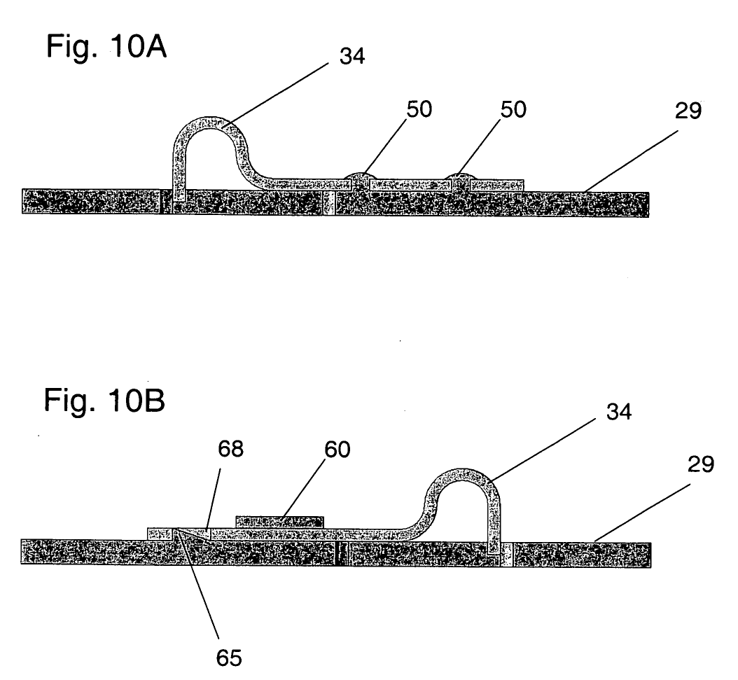

FIGS. 9A-9D and 10A-10B illustrate an embodiment in which the tabs 34 comprise spring steel pieces that are snapped and held in place by retaining features molded into the airbag module housing. In this embodiment, tab holes 45 are located in the airbag module housing 24 to allow the tabs 34 to be depressed while the inflator 20 is rotated to the second position 30.

In FIGS. 9A, 9C, and 10A, the retaining feature comprises two screw-like protrusions 50 extending from the back surface 29 of the airbag module housing 24 through holes located in the tabs 34. The screw-like protrusions 50 can be formed, and the tabs 34 thus attached to the airbag module housing 24, using heat staking, vibration welding, or any other method suitable for such a material displacement.

In FIGS. 9B, 9D, and 10B, the retaining feature comprises two undercut protrusions 60 extending from the back surface 29 of the airbag module housing 24 and wrapping around the sides of the tabs 34. The tab 34 can be slid beneath the undercut protrusions 60. In this embodiment, a triangular protrusion 65 extends from the back surface through a small hole 68 located in the tab 34. After the tab 34 is slid to the point where the small hole 68 passes the triangular protrusion 65, the triangular protrusion 65 prevents the tab 34 from sliding out from beneath the undercut protrusions 60.

FIG. 5 illustrates the details of the undercut sections 32 and bendable tabs 34, according to an exemplary embodiment. The undercut sections 32 act as a slot for flange 26 to slide into. One or more undercut section can provide an interference fit with the inflator flange.

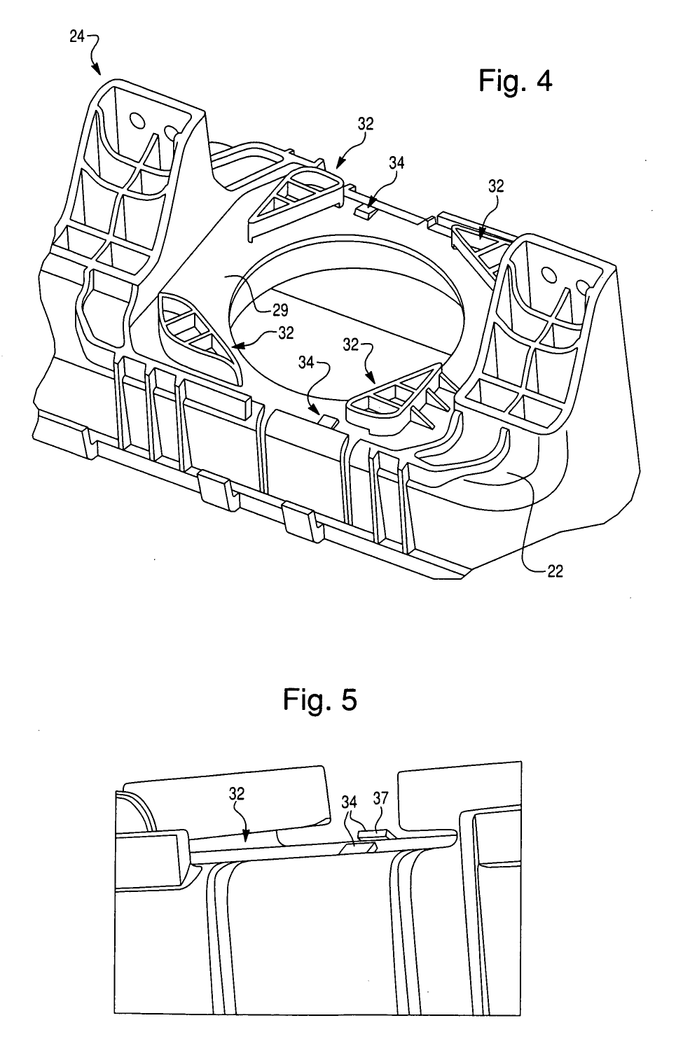

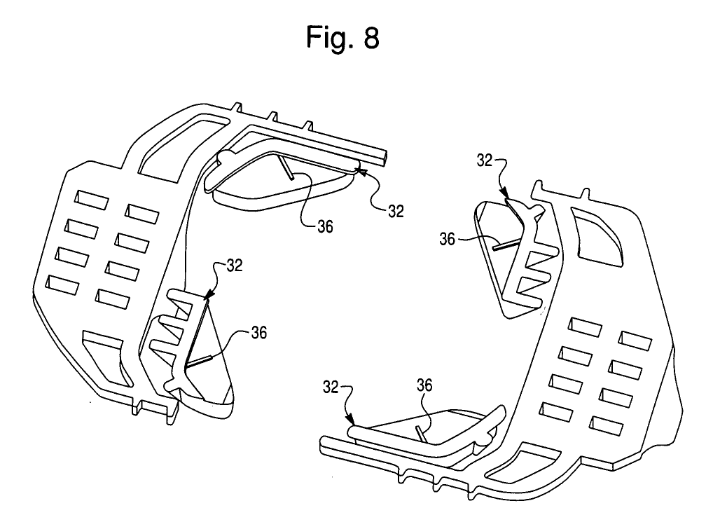

FIG. 8 illustrates ribs 36 on the undercut sections 32, which provide an interference fit with the inflator flange 26 (FIGS. 3A, 3B) in order to prevent vibration of the components. The ribs are located on the underside surface of the undercut sections 32, opposite the back surface 29 (FIG. 4). The ribs 36 can be located on one or more of the undercut sections 32.

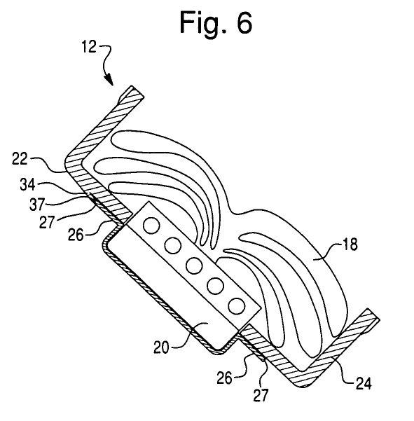

FIG. 6 illustrates the position of a bendable tab 34 after the inflator 20 is in the second position (final, in-use position) 30. The inside edge 37 of the tab 34 is shown contacting the side edge 27 of the flange 26, thus preventing the inflator 20 from rotating and locking the inflator 20 in the second position 30.

In another exemplary embodiment, the module can include an interlock feature that can replace the bendable tabs 34 or, alternatively, be used in addition to the bendable tabs 34. Some of the housing material, in the shape of a puck 40, for example, could be displaced to interlock with a feature of the inflator 20 to attach an airbag inflator 20 to an airbag module housing 24 (FIGS. 3A, 3B). The inflator flange 26 could contain holes 41 similar to holes currently used to connect the inflator 20 to the airbag module housing 24 using screws, studs, and/or nuts. The puck 40 could then be displaced by methods such as heat staking or vibration welding into these holes 41, therefore locking the inflator 20 in position.

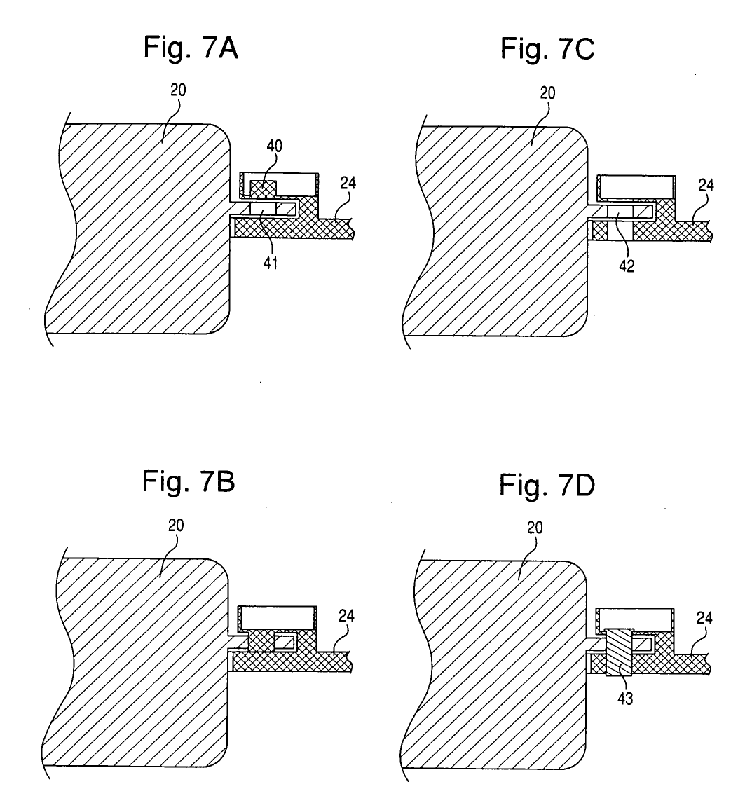

Serviceability of the module could be achieved by removing the displaced material, e.g., by drilling, and placing a separate pin into the hole during re-assembly. FIGS. 7A through 7D illustrate how the airbag module can be serviced. FIG. 7A shows an inflator 20 in second position 30. A raised portion of housing material in the shape of a puck 40 is built into the airbag module housing 24. A hole or notch 41 in the inflator 20 is aligned beneath the puck 40. FIG. 7B shows the module after the material in puck 40 has been displaced into the hole 41, using heat staking, vibration welding, or any other method suitable for such a material displacement. FIG. 7C shows the airbag module housing after the displaced material has been removed, e.g. by drilling, leaving a through hole 42. FIG. 7D shows the airbag module after a pin 43 has been inserted into the through hole 42. The pin 42 can be inserted using an interference fit in order to prevent it from falling out of the through hole 42.

In another exemplary embodiment, the attachment method discussed in this disclosure could be applied to a driver side airbag or any other airbag located within the vehicle utilizing a disk style inflator, or any other suitable inflator.

It is important to note that the construction and arrangement of the attachment method of an airbag inflator to an airbag module housing as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the description. For example, elements shown as integrally formed may be constructed of multiple parts or elements, the position of the elements may be reversed or otherwise varied, and the nature or number of discrete elements or positions may be altered or varied. Other substitutions, modifications, changes and omissions may be made in the design, operating conditions and arrangement of the exemplary embodiments.

What is claimed is:

1. An airbag module, comprising:
a housing for an airbag; and
an inflator configured to be mounted on the housing, the housing comprising at least one undercut section with a slot into which an inflator flange can be slid to mount the inflator onto the housing.

2. The airbag module of claim 1, wherein:
the at least one undercut section is positioned on a back surface of the housing such that the inflator can be rotated from a first position to a second position,
when in the first position, the inflator is located against the back surface and can be freely removed from the housing; and
when in the second position, the inflator flange is held in place in a direction perpendicular to the back surface by the at least one undercut section.

3. The airbag module of claim 2, wherein the at least one undercut section provides an interference fit with the inflator flange.

4. The airbag module of claim 2, further comprising at least one bendable tab positioned on the back surface of the housing such that an inside edge of the bendable tab contacts a side edge of the inflator when the inflator is in the second position.

5. The airbag module of claim 4, wherein the contact between the inside edge of the bendable tab and the side edge of the inflator prevents the inflator from rotating when the inflator is in the second position.

6. The airbag module of claim 5, wherein the bendable tab is formed as an integral part of the housing.

7. The airbag module of claim 5, wherein the bendable tab is formed from separate pieces that are fastened to the airbag module housing.

8. The airbag module of claim 5, wherein the bendable tab is compressed when the inflator is in the first position.

9. The airbag module of claim 5, further comprising a plurality of said bendable tabs.

10. An airbag module for a vehicle, comprising:
a housing for an airbag; and
an inflator configured to be mounted on the housing,
wherein the housing includes at least one integral locking component to lock the inflator into a mounted, in-use position on the housing.

11. The airbag module of claim 10, wherein the at least one integral locking component comprises an undercut section formed in a back surface of the housing.

12. The airbag module of claim 10, wherein the at least one integral locking component comprises a bendable tab formed in a back surface of the housing.

13. A method of attaching an inflator to an airbag module housing comprising:
placing the inflator in a first position against a back surface of the airbag module housing; and
rotating the inflator to a second position such that an inflator flange slides into a slot created by an undercut section located on the back surface of the housing, thus causing the inflator to be held in a direction perpendicular to the back surface of the housing.

14. The method of claim 13, wherein the undercut section provides an interference fit with the inflator flange.

15. The method of claim 13, wherein rotating the inflator causes an inside edge of a bendable tab located on the back surface of the housing to contact a side edge of the inflator flange.

16. The method of claim 13, further comprising displacing a portion of material forming the housing to interlock with holes located on the inflator.

17. The method of claim 16, wherein the displacement is conducted using a method chosen from the group consisting of heat staking and vibration welding.

18. The method of claim 16, further comprising:
removing the displaced material, thus creating a through hole; and
inserting a pin into the through hole.

19. The method of claim 18, wherein drilling is used to remove the displaced material.

20. The method of claim 18, wherein the pin is inserted into the through hole using an interference fit.
